(19) United States
(12) Patent Application Publication
(10) Pub. No.: US 2009/0246609 A1
(43) Pub. Date: Oct. 1, 2009

(54) BATTERY COVER LATCH MECHANISM AND PORTABLE ELECTRONIC DEVICE USING SAME

(75) Inventors: ZHENG SHI, Shenzhen City (CN); CHIH-CHIANG CHANG, Shindian (TW); ZHI LI, Shenzhen City (CN); ZHI-YUN SHEN, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: SHENZHEN FUTAIHONG PRECISION INDUSTRY CO., LTD., ShenZhen City (CN); FIH (HONG KONG) LIMITED, Kowloon (HK)

(21) Appl. No.: 12/254,093

(22) Filed: Oct. 20, 2008

(30) Foreign Application Priority Data
Mar. 26, 2008 (CN) 200810300724.2

(51) Int. Cl. H01M 2/02; H01M 2/00

(52) U.S. Cl. 429/100; 429/96

(57) ABSTRACT

A battery cover latch mechanism (100) used in portable electronic device (200) is described including a cover member (10) and a latch member (20). The cover member defines a fitting cavity (128). The cover member is fitted and slidable within the cavity. The cover member includes a deformable loop structure and a latch portion (26). The loop structure includes a resilient biasing portion (24). The loop structure is deformed and the biasing portion is biased so that the latch member is fitted within the cavity when in a latched position. The loop structure can be further deformed and the biasing portion further biased so that the latch member slides within the fitting cavity and the latch portion is transferred from the latched position to a released position.

### RELATED APPLICATION

This application is related to U.S. Ser. No. 12/166,503, filed Jul. 2, 2008.

### BACKGROUND

1. Field of the Invention

The invention relates to battery cover latch mechanisms used in portable electronic device.

2. Description of Related Art

Portable electronic devices usually include latch mechanisms intended to latch battery covers to housings. The latch mechanisms must tolerate frequent installation and removal of batteries relative to the housings.

A typical battery cover latch mechanism includes at least one spring to facilitate the operation thereof. However, the spring may easily wear out after repeated operation and, thus the battery cover latch mechanism may fail.

Therefore, there is room for improvement within the art.

### BRIEF DESCRIPTION OF THE DRAWINGS

Many aspects of the exemplary a battery cover latch mechanism and a portable electronic device using the battery cover latch mechanism can be better understood with reference to the following drawings. These drawings are not necessarily drawn to scale, the emphasis instead being placed upon clearly illustrating the principles of the exemplary battery cover latch mechanism and the portable electronic device. Moreover, in the drawings like reference numerals designate corresponding parts throughout the several views. Wherever possible, the same reference numbers are used throughout the drawings to refer to the same or like elements of an embodiment.

FIG. 1 is an isometric view of a battery cover latch mechanism according to the exemplary embodiment.

FIG. 2 is an exploded view relative to FIG. 1.

FIG. 3 is another exploded view relative to FIG. 1.

FIG. 4 is similar to FIG. 3 but showing partially.

FIG. 5 is similar to FIG. 4 but at the latched state of the battery cover latch mechanism.

FIG. 6 is an isometric view of a portable electronic device without the battery cover latch mechanism.

FIG. 7 is a sectional view of the portable electronic device in FIG. 6.

### DETAILED DESCRIPTION OF THE EXEMPLARY EMBODIMENTS

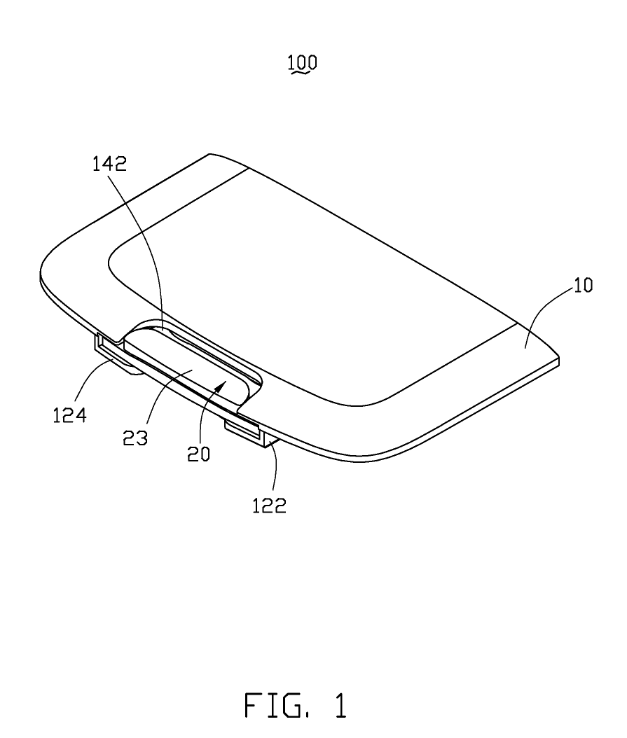

Referring to FIG. 1, the battery cover latch mechanism 100 includes a cover member 10 and a latch member 20 fitted within the cover member 10.

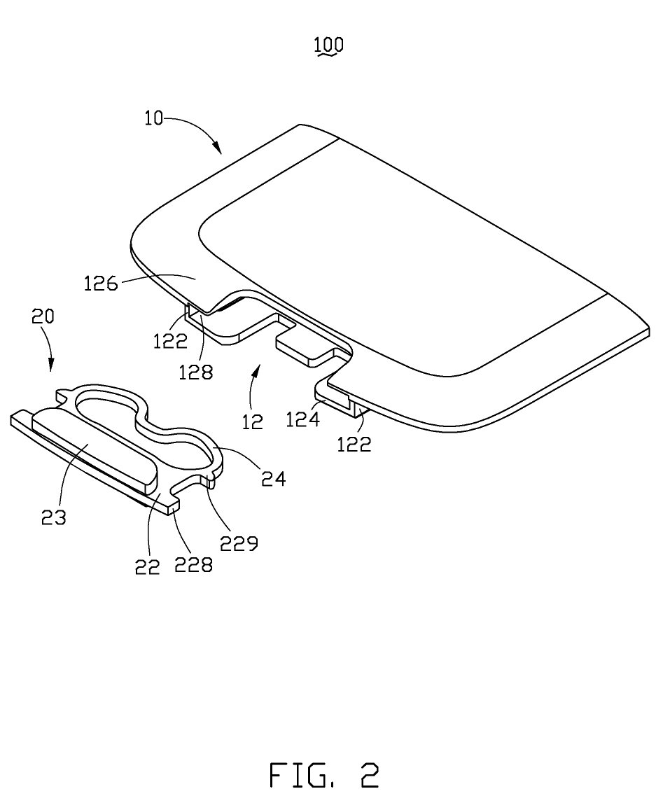

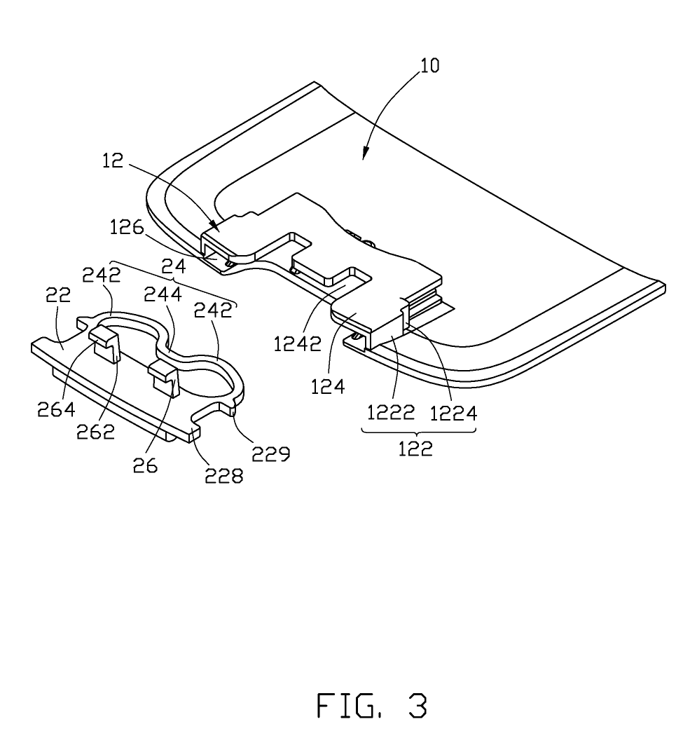

Referring to FIG. 2, the cover member 10 includes a fitting portion 12 at its border. The fitting portion 12 defines a fitting cavity 128 enclosed by two opposite step sidewalls 122, a bottom wall 124, and a top wall 126 opposite the bottom wall 124. Referring to FIG. 3, two first wall portions 1222 connect two second wall portions 1224 making the step sidewalls 122 step-shaped. The two first wall portions 1222 and the two second wall portions 1224 are formed on the top wall 126 connecting the bottom wall 124. The bottom wall 124 defines two slide notches 1242. The two slide notches 1242 are generally rectangular and parallel with each other.

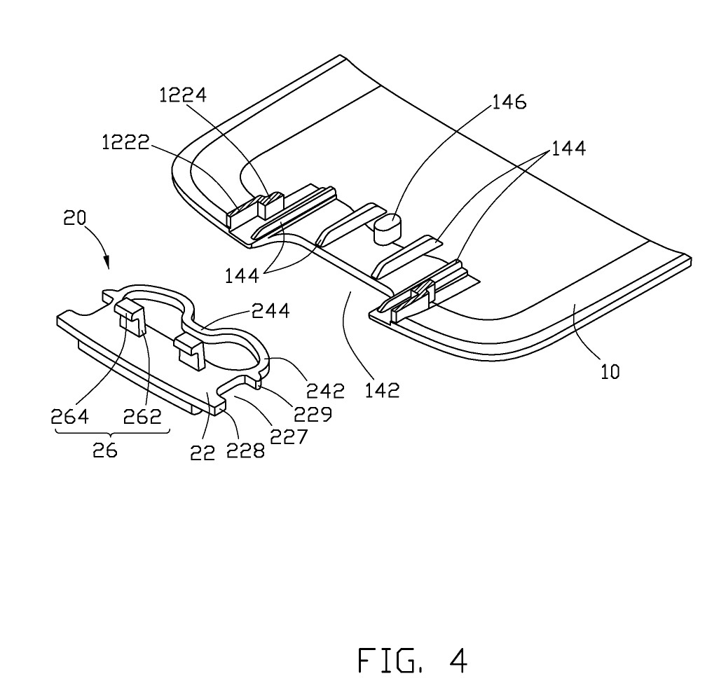

Referring to FIG. 4, the top wall 126 defines a cutout 142, and forms four parallel supporting bars 144 and a resisting block 146 within the fitting cavity 128. The cutout 142 is generally rounded. The four supporting bars 144 protrude from the top wall 126 towards the bottom wall 124. Two of the four supporting bars 144 are near the two step sidewalls 122. The other two supporting bars 144 are shorter relative to the first two supporting bars 144 and have the resisting block 146 disposed therebetween. The resisting block 146 protrudes from the top wall 126 towards the bottom wall 124. The resisting block 146 is closer to the bottom wall 124 than any of the supporting bars 144, and further away from the cutout 142 than any of the supporting bars 144. The resisting block 146 is generally columnar.

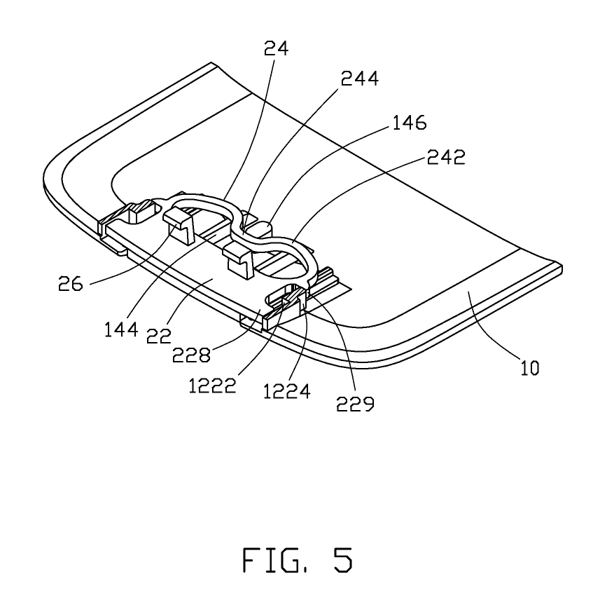

Referring to FIGS. 2 and 3, the latch member 20 includes a base portion 22, a pushing portion 23 and a biasing portion 24, and two latch portions 26. The base portion 22 is a flat board configured to be guided by the supporting bars 144 into the fitting cavity 128. The base portion 22 can further be secured by two securing parts 229 engaging with the two second wall portions 1224 (best seen in FIG. 5). The two securing parts 229 and two limiting parts 228 are formed on opposite sides of the base portion 22. The two securing parts 229 and two limiting parts 228 cooperatively enclose two grooves 227. Each groove 227 is configured to receive one of the two second wall portions 1224 (best seen in FIG. 5).

The pushing portion 23 and the two latch portions 26 protrude from opposite surfaces of the base portion 22. The pushing portion 23 is used to be pushed by a pushing force. The shape of the pushing portion 23 corresponds to the shape of the cutout 142 so the pushing portion 23 can be accommodated and slid in the cutout 142 (best seen in FIG 1). The two latch portions 26 are generally L-shaped, including two connecting parts 262 and two latch parts 264. The connecting parts 262 connect the latch parts 264 to the base portion 22. The latch parts 264 are substantially parallel to the base portion 22.

The biasing portion 24 extends from an edge of the base portion 22 near the two securing parts 229 and away from the pushing portion 23. The biasing portion 24 is resilient and includes two curved sections 242 and a straight section 244. The two curved sections 242 are connected with each other by the straight section 244 and further connect the two securing parts 229. The curved sections 242, the straight section 244, and the base portion 22 cooperatively form a closed loop structure. The closed loop structure is shaped like a typical eye-glass frame, and has two partially enclosed loops arranged at two opposite sides. The partially enclosed loops communicate with each other by a channel arranged at the central portion of the closed loop structure.

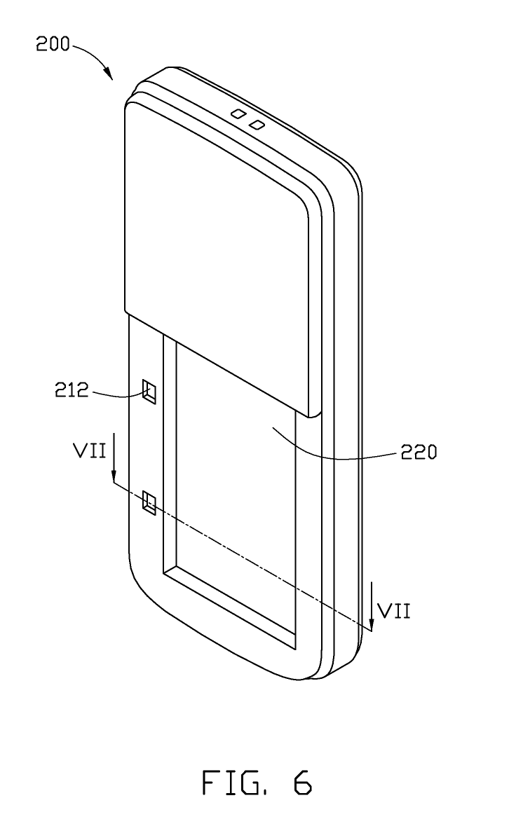

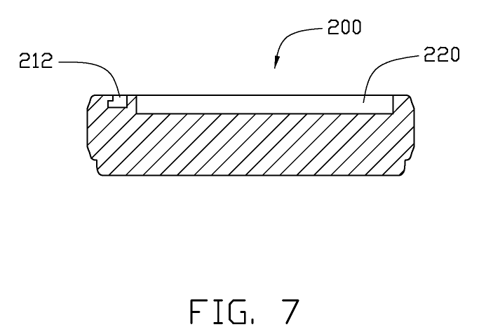

Referring to FIGS. 6 and 7, the battery cover latch mechanism 100 needs to be latched to a portable electronic device 200. The portable electronic device 200 defines a battery chamber 220 for installation of a battery (not shown) and two latching holes 212 adjacent to the battery chamber 220. The two latching holes 212 are step-shaped corresponding to the two latch portions 26 and allowing the two latch portions 26 to engage and secure into the two latching holes 212.

Referring to FIGS. 1 and 5, the battery cover latch mechanism 100 is latched to the portable electronic device 200. At this latched position, the latch member 20 is securely fitted within the cover member 10. The base portion 22 is supported by the four supporting bars 144 and secured in the fittings cavity 128 with the two second wall portions 1224 resisting against the two securing parts 229. The biasing portion 24 is resiliently deformed by the resisting block 146 pressing against the straight section 244. Also, the two latch portions 26 are latched in the two latching holes 212 of the portable electronic device 200. The pushing portion 23 is positioned in the cutout 142 with a clearance. The latch portions 26 are placed in the slide notches 1242 with a clearance. The cover member 10 covers sides of the portable electronic device 200 and locks the battery in the battery chamber 220.

Removing the battery from battery chamber 220 requires releasing the latching of the battery cover latch mechanism 100. The pushing portion 23 is pushed inside of the cutout 142. The base portion 22 moves along the supporting bars 144 towards the resisting block 146. During this stage, the biasing portion 24 is further resiliently deformed by the resisting block 146 pressing more against the straight section 244. Simultaneously, the latch portions 26 move along the base portion 22 toward the resisting block 146 and slide inside the slide notches 124. The latch portions 26 also move relative to the latching holes 212 from the latched position to a released position.

When the latch portions 26 reach the released position, the latch portions 26 upwardly disengage from the latching holes 212. At this time, upward movement of the cover member 10 relative to the electronic device 200 allows removal of the latch portions 26 from the latching holes 212. Thus, the battery cover latch mechanism 100 is released from the portable electronic device 200, exposing the battery installed in the battery chamber to the outside. A removal of the battery can be easily done.

In addition, as best seen in FIG. 5, the two limiting parts 228 limit the above described moving of the base portion 22 by abutting the first wall portions 1222. The biasing portion 24 can return to its original state after removal of the pushing force. The resilient force of the biasing portion 24 drives the base portion back to its original state.

It is to be understood, however, that even through numerous characteristics and advantages of the exemplary invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1 A battery cover latch mechanism, comprising:
a cover member defining a fitting cavity;
a latch member fitted and slidable within the cavity, the latch member comprising a deformable loop structure and a latch portion, the loop structure comprising a resilient biasing portion, the loop structure deformed and the biasing portion biased so that the latch member is fitted within the cavity when in a latched position, the loop structure further deformed and the biasing portion further biased so that the latch member slides within the fitting cavity and the latch portion is transferred from the latched position to a released position.

2. The battery cover latch mechanism as claimed in claim 1, wherein:
the biasing portion comprises two curved sections and a straight section, the two curved sections connected with each other by the straight section; and
the cover member comprises a resisting block, the loop structure being deformed and the biasing portion being biased by the resisting block pressing against the straight section.

3. The battery cover latch mechanism as claimed in claim 2, wherein when the latch portion is moved from the latched position to the released position, the latch portion moves toward the resisting block.

4. The battery cover latch mechanism as claimed in claim 3, wherein the latch member further comprises a base portion, the loop structure is closed, and the base portion, the curved sections, and the straight section cooperatively form a closed loop structure.

5. The battery cover latch mechanism as claimed in claim 4, wherein:
the base portion comprises two securing parts; and
the cover member comprises two wall portions resisting against the two securing parts when the latch member is in the latched position, the two wall portions detaching from the two securing parts when the latch member is in the released position.

6. The battery cover latch mechanism as claimed in claim 4, wherein:
the base portion comprises two limiting parts; and
the cover member comprises two wall portions detached from the two limiting parts when the latch member is in the latched position, the two limiting parts are configured for limiting the sliding of the latch member by abutting the two wall portions.

7. The battery cover latch mechanism as claimed in claim 2, wherein the cover member comprises a fitting portion, the fitting cavity defined in the fitting portion, the fitting portion comprises at least one support bar configured for supporting the latch member, the latch member configured for sliding along the at least one support bar.

8. The battery cover latch mechanism as claimed in claim 7, wherein the fitting portion comprises two opposite step sidewalls, a bottom wall, and a top wall opposite the bottom wall, the resisting block and the at least one support bar formed on the top wall.

9. The battery cover latch mechanism as claimed in claim 8, wherein:
the top wall defines a cutout;
the bottom wall defines a slide notch; and
the latch member further comprises a pushing portion located opposite to the latch portion, the pushing portion configured for being accommodated and slid in the cutout, the latch portion configured for being accommodated and slid in the slide notch.

10. A portable electronic device, comprising:
a battery chamber;
a battery cover latch mechanism, comprising:
a cover member defining a fitting cavity;
a latch member fitted and slidable within the fitting cavity, the latch member comprising a deformable loop structure and a latch portion, the loop structure comprising a resilient biasing portion;
wherein the loop structure is deformed and the biasing portion is biased so that the latch member is fitted within the cavity when in a latched position, the cover member securely covering the battery chamber at the latched position by the latching of the latch member; and
the loop structure is further deformed and the biasing portion is further biased so that the latch member slides within the fitting cavity and the latch portion is transferred from the latched position to a released position.

11. The portable electronic device as claimed in claim 10, wherein:
the biasing portion comprises two curved sections and a straight section, the two curved sections connected with each other by the straight section; and
the cover member comprises a resisting block, the loop structure being deformed and the biasing portion being biased by the resisting block resisting against the straight section.

12. The portable electronic device as claimed in claim 11, wherein when the latch portion is transferred from the latched position to the released position, the latch portion moves toward the resisting block.

13. The portable electronic device as claimed in claim 12, wherein the latch member further comprises a base portion, the loop structure is closed, and the base portion, the curved sections, and the straight section cooperatively form the closed loop structure.

14. The portable electronic device as claimed in claim 13, wherein:
the base portion comprises two securing parts; and
the cover member comprises two wall portions resisting against the two securing parts when the latch member is in the latched position, the two wall portions detach from the two securing parts when the latch member is in the released position.

15. The portable electronic device as claimed in claim 13, wherein:
the base portion comprises two limiting parts; and
the cover member comprises two wall portions detached from the two limiting parts when the latch member is in the latched position, the two limiting parts are configured for limiting the sliding of the latch member by abutting the two wall portions.

16. The portable electronic device as claimed in claim 11, wherein the cover member comprises a fitting portion, the fitting cavity defined in the fitting portion, the fitting portion comprises at least one support bar configured for supporting the latch member, the latch member configured for sliding along the at least one support bar.

17. The portable electronic device as claimed in claim 16, wherein the fitting portion comprises two opposite step sidewalls, a bottom wall, and a top wall opposite the bottom wall, the resisting block and the at least one support bar formed on the top wall.

18. The portable electronic device as claimed in claim 17, wherein:
the top wall defines a cutout;
the bottom wall defines a slide notch; and
the latch member further comprises a pushing portion located opposite to the latch portion, the pushing portion configured for being accommodated and slid in the cutout, the latch portion configured for being accommodated and slid in the slide notch.

19. The portable electronic device as claimed in claim 10, further comprising a latching hole configured for allowing the latch portion to engage and secure thereinto.

20. The portable electronic device as claimed in claim 19, wherein the latch portion and the latching hole are L-shaped, the latching hole configured for allowing a removal of the latching portion therefrom.
